(19) United States
(12) Patent Application Publication
(10) Pub. No.: US 2024/0425081 A1
(43) Pub. Date: Dec. 26, 2024

(54) Method and Apparatus for Generating at Least One Training Travel Trajectory for Training a Driving Mode of a Self Driving Vehicle

(71) Applicant: Robert Bosch GmbH, Stuttgart (DE)

(72) Inventors: Martin Stoll, Renningen (DE); Markus Mazzola, Tuebingen (DE); Maxim Dolgov, Renningen (DE)

(21) Appl. No.: 18/753,037

(22) Filed: Jun. 25, 2024

(30) Foreign Application Priority Data
Jun. 26, 2023 (DE) 10 2023 205 982.7

(51) Int. Cl. B60W 60/00; B60W 40/04

(52) U.S. Cl. CPC B60W 60/0015; B60W 40/04; B60W 2520/10; B60W 2554/80

(57) ABSTRACT

A method is for generating at least one training travel trajectory for training a driving mode of a self driving vehicle. The method includes reading in a possible travel trajectory of a vehicle and a safety time parameter representing a time period within which a safety distance to an assumed vehicle in front is to be maintained again after a deviation of a position and/or speed of the vehicle on the travel trajectory, and determining position deviation data and/or speed deviation data to change an assumed position and/or speed of the vehicle on the travel trajectory at a specific and/or predefined time. The method further includes determining the training travel trajectory using the travel trajectory, the safety time parameter, the position deviation data and/or the speed deviation data.

This application claims priority under 35 U.S.C. § 119 to patent application no. DE 10 2023 205 982.7, filed on Jun. 26, 2023 in Germany, the disclosure of which is incorporated herein by reference in its entirety.

### BACKGROUND

In imitation learning, the training data is augmented, i.e., supplemented with situations that reduce distribution mismatch. In order to continue to have realistic training data, typically existing data is modified within narrow limits. An effective and preferred method is used, for example, in which the trajectories traveled are modified by an additional, time-limited acceleration profile (longitudinal or transverse). The training data are thus supplemented with states that deviate from the demonstration but restore the target state. In this way, the model should learn a stabilizing behavior in order to be able to compensate for deviations from demonstrated behavior.

However, upon closer examination, this type of perturbation is not ideal in the longitudinal direction. If the training data is to be supplemented with excessively fast driving, the additional acceleration profile should first accelerate (phase 1) and then decelerate again (phase 2). The perturbed (i.e., intentionally “distorted” or disturbed in parts with disturbance parameters) trajectory therefore has a higher average speed than the non-perturbed trajectory. In the case of subsequent travel, two options are provided for synchronizing the two trajectories:

Too close an approach is achieved by matching perturbated and non-perturbated trajectories at the start of phase 2 in the location. The target behavior (phase 2) that the policy should learn thus demonstrates braking, but the self driving vehicle (SDV) travels significantly closer to the vehicle in front than in the non-perturbated data. The learned behavior does not remain safe.

Alternatively, the excess speed is completely adjusted to the safe state, i.e. perturbated and non-perturbed trajectories match at the end of phase 2. The states seen in the training then have a higher speed compared to the non-perturbated data, but also greater safety distances. The training data set is only insufficiently supplemented with critical situations.

In both cases, it is not possible to achieve truly uncertain conditions including safe continuation in the training data.

In a completely different method, which addresses distribution mismatch, non-safe or critical states are generated by means of the trained planning or predictive model in simulation, which are then corrected again by an expert model. However, since both a realistic simulation and an expert model must be present here, these methods are only partially applicable in practice.

### SUMMARY

In light of this, with the approach presented here, a method as well as an apparatus and/or control unit which uses this method, and finally a corresponding computer program are proposed.

The present approach creates a method for generating at least one training travel trajectory for training a driving mode of a self driving vehicle, wherein the method comprises the following steps:
reading in a possible travel trajectory of a vehicle and a safety time parameter representing a time period within which a safety distance from an assumed vehicle in front is to be maintained again after a deviation of a position and/or speed of the vehicle on the travel trajectory;
determining position deviation data and/or speed deviation data to change an assumed position and/or speed of the vehicle on the travel trajectory at a specific and/or predefined time; and
determining the training travel trajectory using the travel trajectory, the safety time parameter, the position deviation data and/or the speed deviation data, wherein the training travel trajectory is determined such that the safety distance to the assumed vehicle in front is fulfilled at least after a time period corresponding to the safety time parameter has elapsed.

A travel trajectory of the vehicle may be understood to mean a movement path with time information or a trajectory representing an assumed travel path of the vehicle. In the present case, a safety time parameter may be understood to mean a parameter within which a vehicle, after a deviation from the travel trajectory with respect to a speed and/or a position, returns to a state in which it constantly travels at a safe distance to an assumed, hypothetical, vehicle in front. However, this vehicle driving in front, which can also be referred to as the vehicle in front, is only to be assumed to be virtual, so that this vehicle in front no longer needs to be present or considered for the training travel trajectory that is ultimately to be determined, with which a driving behavior of a self driving vehicle is to be trained in a subsequent method. Instead, the assumption of the position of the vehicle in front is mapped in the sequence of the individual positions of the vehicle in the training travel trajectory. Position deviation data may be understood to mean position data by which a position and/or orientation of the vehicle on the travel trajectory can be changed or shifted at individual positions, such that disturbances of the positions of the vehicle on the travel trajectory can be mapped or simulated to generate the training travel trajectory. Similarly, speed deviation data may be understood to mean to speed data with which a speed of the vehicle can be changed at individual positions on the travel trajectory, such that disturbances of the speeds at the different positions of the travel trajectory may also be mapped or simulated to generate the training travel trajectory. In the present case, a safety distance may be understood to mean a distance that represents a safety distance to the assumed vehicle in front, which is to be maintained by the vehicle moving on the training travel trajectory after a time period corresponding to the safety time parameter has elapsed. Thus, the training travel trajectory is to be determined such that a desired or required safety distance is met or maintained again after a short time period even if, for example, the vehicle is too close to the assumed vehicle in front.

The approach presented here is based on the knowledge that by using position deviation data and/or speed deviation data when modifying a travel trajectory of the vehicle, taking into account the safety distance parameter, it is possible to find a way of mapping the driving behavior of a vehicle even in critical situations, such as driving too close to the vehicle in front, without actually having to record data for this vehicle in front in the training travel trajectory, on the one hand, and being able to map very realistic driving on a road by the driver on the other. This realistic driving can be mapped, for example, by the fact that a driving state can now also be mapped in the training travel trajectory in which the vehicle travels more closely or closer to the vehicle in front at a slower travel speed, while still driving safely in traffic in accordance with the rules. The training travel trajectory to be determined can thus be used to extend the driving profile to be trained in such a way that not only can the driving behavior be statically adjusted to a fixed predetermined safety distance, but this safety distance can be varied in a speed-dependent manner, thus significantly improving precise training of the autonomous driving algorithm even in critical driving situations.

The approach presented herein allows the determination of a training travel trajectory by the generation of a perturbation of a (travel) trajectory, which on the one hand contains critical states, but on the other hand also regulates them safely. The drawbacks of conventional perturbation are solved without relying on interactive simulation or on expert modeling.

Particularly favorable is an embodiment of the approach proposed herein in which in the determining step, the position deviation data and/or the speed deviation data is determined using a probability distribution for position deviation data and/or speed deviation data. For example, a normal distribution, a poission distribution, or the like may be used as a probability distribution. Such an embodiment provides the advantage of generating a quasi-random selection of the position deviation data and/or the speed deviation data in order to thereby generate a randomness of the disturbances with which the travel trajectory for the training travel trajectory is changed. As a result, an improved and more robust driving behavior of the self driving vehicle may be achieved.

Furthermore, an embodiment of the approach proposed herein is conceivable in which in the step of reading in, a time duration parameter is read in which represents a time duration with which the vehicle reaches an assumed vehicle in front at a current assumed speed, and wherein in the determining step, the training travel trajectory is determined using the time period parameter. Alternatively or additionally, in the step of reading in, a safety distance parameter may be read in, which represents a safety distance when stationary that the vehicle is to maintain to an assumed vehicle in front, and wherein in the determining step, the training travel trajectory is determined using the safety distance parameter. For example, such a time period parameter may be understood to mean a time duration or interval that is required to close up to a fixed predefined safe distance to the vehicle in front in a known assumed safe zone. The explicit selection of such a of time period parameter allows for flexible setting of a driving behavior, which can then be trained into a self driving vehicle.

According to a further embodiment of approach proposed here, in the determining step, the training travel trajectory is determined using an acceleration, wherein the acceleration is determined using the current assumed position of the vehicle on the travel trajectory, a current assumed speed of the vehicle on the travel trajectory, the position deviation data, the speed deviation data, the safety time parameter and the time period parameter. Specifically, determining the temporal flexible and variable acceleration proposed herein allows for a very precise variation of assumed positions of the vehicle/or a determination of speeds at these positions of the vehicle so that the aforementioned advantages can be efficiently implemented or realized.

An embodiment of the approach proposed herein can be realized with particular precision and conformity to the desired requirements, in which, in the determining step, the training travel trajectory is determined using an assumed position of the vehicle at a specific time, wherein the assumed position of the vehicle is determined using the assumed position of the vehicle on the travel trajectory at the time, a current assumed speed of the vehicle on the travel trajectory at the time, the position deviation data, the speed deviation data, the safety time parameter and the time duration parameter.

Similarly, an embodiment of the approach proposed herein can also be used for precise adaptation to desired general conditions, in which in the determining step, the training travel trajectory is determined using an assumed speed of the vehicle at a specific time, wherein the assumed speed of the vehicle is determined using the assumed position of the vehicle on the travel trajectory at the time, a current assumed speed of the vehicle on the travel trajectory at the time, the position deviation data, the speed deviation data, the safety time parameter and the time duration parameter.

In order to be able to map the corresponding positions and/or speeds of the vehicle over a longer time period and thereby comply with the desired boundary conditions, in accordance with an embodiment of the approach proposed herein, in the determining step, individual assumed positions and/or speeds of the vehicle in the training travel trajectory may be determined by determining the positions and/or speeds for different times on the training travel trajectory. For example, an (assumed) position and/or (assumed) speed of the vehicle is determined for each time or time interval and stored in the training travel trajectory for this corresponding time or the corresponding time interval.

In order to obtain a training travel trajectory which is as realistic as possible, according to one embodiment of the approach proposed herein, in the determining step, the training travel trajectory may be determined such that an assumed speed of the vehicle is non-negative at all positions in the training travel trajectory. In this way, certain values that are technically unrealistic or physically not useful may be immediately discarded.

Similarly, in order to map a driving behavior of the vehicle as realistically as possible, according to a further embodiment of the approach proposed herein, in the determining step, the training travel trajectory can be determined in such a way that a lateral acceleration that does not exceed a lateral acceleration threshold value acts on a vehicle moving in accordance with the training trajectory. In the present case, a lateral acceleration threshold value may be understood to mean, for example, a value that represents a lateral acceleration acting on the vehicle at which the vehicle would be carried out of a curve.

According to a further embodiment of the approach proposed here, at least one of the steps of the method can be repeated iteratively, specifically for optimizing a learning behavior of the self driving vehicle over a longer travel path or over a longer time period, in particular if the training travel trajectory represents a driving behavior of the vehicle over a longer time interval than the safety time parameter.

For example, this method can be implemented in software or hardware, or in a mixed form of software and hardware, for example in a control device.

The approach presented here further provides an apparatus which is designed to perform, control, or implement, in corresponding devices, the steps of a variant of a method presented herein. The object of the disclosure can also be achieved quickly and efficiently by means of this embodiment variant of the disclosure in the form of an apparatus.

For this purpose, the apparatus can comprise at least one computing unit for processing signals or data, at least one memory unit for storing signals or data, at least one interface to a sensor or an actuator for reading in sensor signals from the sensor or for emitting data or control signals to the actuator, and/or at least one communication interface for reading in or emitting data embedded in a communication protocol. The computing unit may, for example, be a signal processor, a microcontroller or the like, wherein the memory unit may be a flash memory, or a magnetic memory unit. The communication interface can be designed to read in or emit data in a wireless and/or wired manner, wherein a communication interface capable of reading in or emitting wired data can read in said data from a corresponding data transmission line, for example electrically or optically, or emit said data to a corresponding data transmission line.

In this context, the term “apparatus” can be understood to mean an electrical device that processes sensor signals and emits control signals and/or data signals as a function thereof. The apparatus can comprise an interface, which can be designed as hardware and/or software. For example, given a hardware design, the interfaces can be part of what is referred to as an ASIC system, which contains a wide variety of functions for the apparatus. However, it is also possible that the interfaces are dedicated integrated circuits or consist at least partly of discrete components. When implemented as software, the interfaces can be software modules present, for example, on a microcontroller alongside other software modules.

Also advantageous is a computer program product or computer program comprising program code which is stored on a machine-readable carrier or storage medium, e.g., a semi-conductor memory, a hard disk memory, or an optical memory and used in order to perform, implement and/or control the steps of the method according to one of the embodiments described above, in particular if the program product or program is executed on a computer or an apparatus.

### BRIEF DESCRIPTION OF THE DRAWINGS

Exemplary embodiments of the approach presented herein are shown in the drawings and explained in greater detail in the following description. The figures shows:

FIG. 1 a schematic illustration of the creation of a training travel trajectory which maps a movement path of a vehicle;

FIG. 2 a flow chart of a method according to an exemplary embodiment;

FIG. 3 a flowchart of an exemplary embodiment of a method for generating at least one training travel trajectory for training a driving mode of a self driving vehicle;

FIG. 4 a block diagram of an exemplary embodiment of an apparatus for generating at least one training travel trajectory for training a driving mode of a self driving vehicle; and

FIG. 5 a flow chart of an exemplary embodiment of a method 500 for training a self driving vehicle.

### DETAILED DESCRIPTION

In the following description of advantageous exemplary embodiments of the disclosure, identical or similar reference signs are used for elements shown in the various drawings having a similar function, so a repeated description of these elements has been omitted.

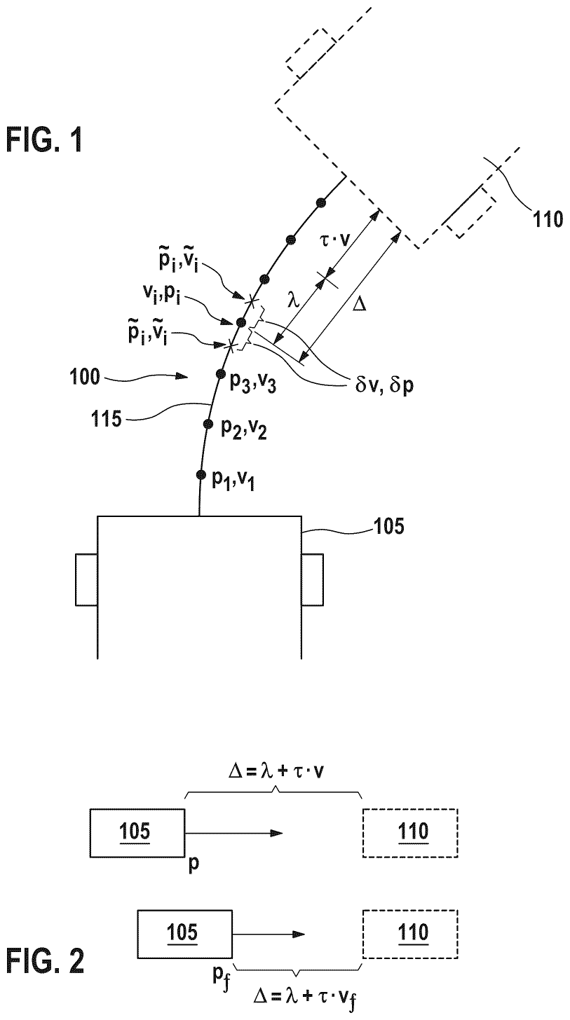

FIG. 1 shows a schematic representation of the creation of a training travel trajectory 100 that maps a movement path of a vehicle 105 traveling behind, for example, a vehicle in front 110. The training travel trajectory 100, which is to be determined using the approach presented herein, serves to train in a driving behavior of a self driving vehicle, such that the self driving vehicle ultimately behaves like the vehicle 105 in its driving behavior. To now determine the training travel trajectory 100, first a travel trajectory 115 is provided or read into a corresponding generation unit, wherein said travel trajectory 115 maps a temporal sequence in which the vehicle 105 is located at certain locations pᵢ and at certain speeds vi for the times i=1, . . . n. However, it is assumed that the vehicle 105 is always at a certain safety distance Δ behind the vehicle in front 110, wherein this safety distance Δ is composed of a fixed safety distance λ when stationary and a speed-dependent safety distance, wherein this speed-dependent safety distance is composed by the product of the current speed v of the (assumed) vehicle 105 with a safety time period τ. An important aspect of the approach presented herein can thus be seen in the definition of the safety distance Δ to the (imagined) vehicle in front 110, which can be defined in accordance with the following relationship:

$$Δ = λ + τ + v$$

wherein:
λ: Stationary safe distance
τ: parameters, e.g. 1-2 seconds for subsequent travel; and
v: current speed

In order to now obtain the training travel trajectory 100 from the travel trajectory 115, one or more individual/single time(s) in the training data of the travel trajectory 115 are perturbated as follows, for example:
The position of the vehicle 105 is shifted forwards of backwards along the traveled (travel) trajectory 115 by position deviation data δp, such that a variation of the positions pi results in the position \tilde{p}i at the time in question.
Alternatively or additionally, the scalar speed of the vehicle 105 is increased or decreased by speed deviation data δv, so that from the speed vi results in the speed \tilde{v}i at time in question.
The future trajectory as training travel trajectory 100 represents the desired behavior of the self driving vehicle and is modified by a constant speed profile such that after a set time interval θ, a safe distance, i.e. the safe distance Δ to the (imaginary) vehicle in front 115, is given again. The plausible assumption that a safe distance is always maintained in the non-perturbated data is sufficient.

This consideration makes it possible, for example, to regulate a safe distance Δ at an initially increasing speed \tilde{v}i, which, which has a smaller distance than in the non-perturbated data, but at a slower speed.

FIG. 2 shows a graph in which there is a correlation between the change in the safety distance in the original case from the travel trajectory 115 (upper representation from FIG. 2) and the modified case from the training travel trajectory 100 (lower representation from FIG. 2). It was assumed here that the speed deviation data δv would now result in a lower speed \tilde{v}i of the vehicle 105, so that the safety distance Δ can also be reduced without endangering the vehicle 105.

The following assumptions may also be used to generate the training travel trajectory 100:
the expert whose driving behavior is to be imitated, always keeps a safe forward distance; and
the Δ=λ+τ·v⁻ model describes the safe distance sufficiently well

For example, the algorithm described below may be used to determine the individual positions and/or speeds. Here, the initial state of the self driving vehicle 105 SDV (which is located at a position along the trajectory at a speed v at time i) whose driving behavior is perturbed according to a probability distribution (e.g., a uniform distribution in intervals [−2; 2] m as position deviation data δp=pi−\tilde{p}i and/or [−2; 2] m/s as speed deviation data δv=vi−\tilde{v}i. The perturbated state may violate the safety distance Δ, which is desired in the training data of the training travel trajectory 100.

When perturbating the state, care should also be taken to avoid a collision with the (imaginary) driver ahead or the vehicle in front 110, taking into account a maximum acceleration a. Perturbations that violate this assumption may be disregarded.

The future trajectory or training travel trajectory 100 is now changed with a constant acceleration profile a such that a safe state is achieved again at the time θ.

At this time, the (imaginary) vehicle in front is at a position along the trajectory pf+Δ=pf+λ+τ·vf. The perturbated state should therefore satisfy the equation:

$${\tilde{p}}_{f} + \tilde{Δ} = {\tilde{p}}_{f} + λ + τ \cdot {\tilde{v}}_{f} = {p}_{f} + λ + τ \cdot {v}_{f}$$

The following applies (constant additional acceleration a):

$${\tilde{v}}_{f} = {v}_{f} + ( {\tilde{v}}_{i} - {v}_{i} ) + a \cdot θ$$

$${\tilde{p}}_{f} = {p}_{f} + ( {\tilde{p}}_{i} - {p}_{i} ) + ( {\tilde{v}}_{i} - {v}_{i} ) \cdot θ + \frac{1}{2} \cdot a \cdot {θ}^{2}$$

These equations may have the following solution:

$$a = - 2 \frac{( {\tilde{p}}_{i} - {p}_{i} ) + ( {\tilde{v}}_{i} - {v}_{i} ) \cdot ( θ + τ )}{{θ}^{2} + 2 \cdot θ \cdot τ}$$

$${\tilde{v}}_{f} = {v}_{f} - ( {\tilde{p}}_{i} - {p}_{i} ) \cdot \frac{2}{θ + 2 \cdot τ} - ( {\tilde{v}}_{i} - {v}_{i} ) \cdot \frac{θ}{θ + 2 \cdot τ}$$

$${\tilde{p}}_{f} = {p}_{f} + ( {\tilde{p}}_{i} - {p}_{i} ) \cdot \frac{2 \cdot τ}{θ + 2 \cdot τ} + ( {\tilde{v}}_{i} - {v}_{i} ) \cdot \frac{θ \cdot τ}{θ + 2 \cdot τ}$$

Additional limitations may be easily integrated, e.g. to prevent reversing in the target trajectory, i.e. a non-negative speed should be assumed, or kinematic boundary conditions such as a maximum lateral acceleration in the curves should be maintained, i.e. a maximum lateral acceleration threshold value should not be exceeded.

If the target trajectory is to cover a longer time horizon compared to the safety time parameter θ, the algorithm may be applied iteratively, so one or more steps may be performed repeatedly. The perturbated trajectory or training travel trajectory 100 then becomes increasingly similar to the non-perturbated travel trajectory 100.

The probability distribution with which the initial state is perturbated, as well as the time period parameters τ and the safety time parameter θ are parameters of the example algorithm presented herein and should be selected depending on the training data or the travel trajectory 115. This makes the algorithm flexible and versatile to use.

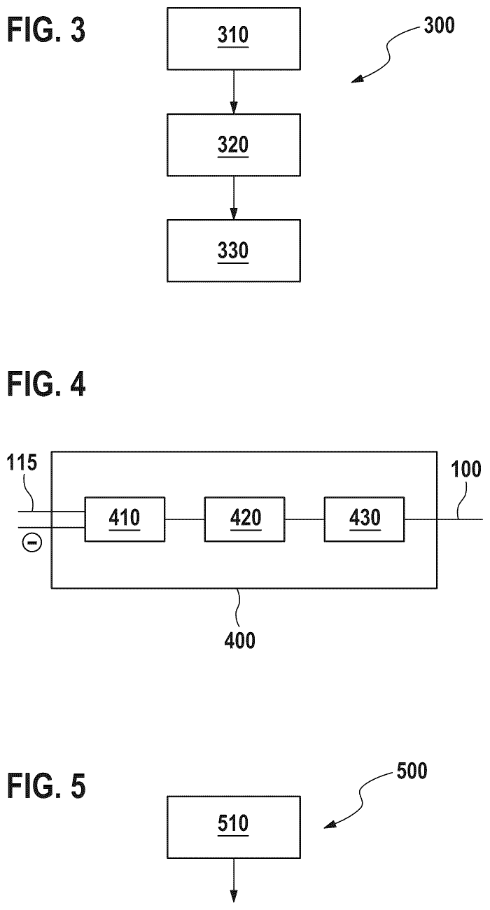

FIG. 3 shows a flowchart of an exemplary embodiment of a method 300 for generating at least one training travel trajectory for training a driving mode of a self driving vehicle. The method 300 comprises a step 310 of reading in a possible travel trajectory of a vehicle and a safety time parameter representing a time period within which a safety distance from an assumed vehicle in front is to be maintained again after a deviation of a position and/or speed of the vehicle on the travel trajectory. Furthermore the method 300 comprises a step 320 of determining position deviation data and/or speed deviation data to change an assumed position and/or speed of the vehicle on the travel trajectory at a specific and/or predefined time. Finally, the method 300 comprises a step 330 of determining the training travel trajectory using the travel trajectory, the safety time parameter, the position deviation data and/or the speed deviation data, wherein the training travel trajectory is determined such that the safety distance to the assumed vehicle in front is fulfilled at least after a time period corresponding to the safety time parameter has elapsed.

FIG. 4 shows a block diagram of an apparatus 400 for generating at least one training travel trajectory for training a driving mode of a self driving vehicle. The apparatus 400 comprises a reading unit 410 for reading in a possible travel trajectory of a vehicle and a safety time parameter representing a time period within which a safety distance from an assumed vehicle in front is to be maintained again after a deviation of a position and/or speed of the vehicle on the travel trajectory. Furthermore the apparatus 400 comprises a unit 420 for determining position deviation data and/or speed deviation data to change an assumed position and/or speed of the vehicle on the travel trajectory at a specific and/or predefined time. Finally, the apparatus 400 comprises a unit 430 for determining the training travel trajectory using the travel trajectory, the safety time parameter, the position deviation data and/or the speed deviation data, wherein the training travel trajectory is determined such that the safety distance to the assumed vehicle in front is fulfilled at least after a time period corresponding to the safety time parameter has elapsed.

FIG. 5 shows a flowchart of an exemplary embodiment of a method 500 for training a self driving vehicle, wherein the method comprises a step 510 of adapting a travel algorithm using a training travel trajectory generated according to a variant of a method for generating a training travel trajectory presented herein.

In summary, it should be noted that data-based learning methods in modern vehicles are increasing finding their way into highly automated driving. A current research field here is the planning step in particular, which uses an environmental model to generate the target behavior of the automated vehicle (also known as SDV=self driving vehicle). One problem here is covariate shift or distribution mismatch: If the policy encounters a new situation in the application which is underrepresented or not represented in the training data, it often exhibits incorrect behavior. For example, even a straightforward follow-up travel is particularly striking: the expert, whose behavior is used to generate the training data, maintains a sensible safety distances from the vehicle in front. The training data therefore lacks critical situations in which the vehicle is too close. As a result, the policy does not learn how it should to react if the safety distance is exceeded. The approach presented here creates a very elegant and robust training method in order to be able to cover training scenarios that could not previously be mapped and thus enable a significant improvement in the robustness of the self driving algorithm.

If an exemplary embodiment comprises an “and/or” conjunction between a first feature and a second feature, this is to be read such that the exemplary embodiment according to one embodiment comprises both the first feature and the second feature and according to a further embodiment comprises either only the first feature or only the second feature.

What is claimed is:

1. A method for generating at least one training travel trajectory for training a driving mode of a self driving vehicle, the method comprising:
reading in a possible travel trajectory of a vehicle and a safety time parameter representing a time period within which a safety distance to an assumed vehicle in front is to be maintained again after a deviation of a position and/or a speed of the vehicle on the travel trajectory;
determining position deviation data and/or speed deviation data to change an assumed position and/or an assumed speed of the vehicle on the travel trajectory at a specific and/or predefined time; and
determining a training travel trajectory using the travel trajectory, the safety time parameter, the position deviation data, and/or the speed deviation data,
wherein the training travel trajectory is determined such that the safety distance to the assumed vehicle in front is fulfilled at least after a time period corresponding to the safety time parameter has elapsed.

2. The method according to claim 1, wherein the position deviation data and/or the speed deviation data is determined using a probability distribution for the position deviation data and/or the speed deviation data.

3. The method according to claim 1, wherein:
reading in the possible travel trajectory comprises reading in a time period parameter representing a time duration with which the vehicle reaches the assumed vehicle in front at a current assumed speed, and the training travel trajectory is determined using the time period parameter, and/or
reading in the possible travel trajectory comprises reading in a safety distance parameter representing a safety distance when stationary which the vehicle is to maintain with respect to the assumed vehicle in front, and the training travel trajectory is determined using the safety distance parameter.

4. The method according to claim 3, wherein:
the training travel trajectory is determined using an acceleration, and
the acceleration is determined using the current assumed position of the vehicle on the travel trajectory, a current assumed speed of the vehicle on the travel trajectory, the position deviation data, the speed deviation data, the safety time parameter, and the time period parameter.

5. The method according to claim 3, wherein:
the training travel trajectory is determined using the assumed position of the vehicle at a specific time, and
the assumed position of the vehicle is determined using the assumed position of the vehicle on the travel trajectory at the specific time, a current assumed speed of the vehicle on the travel trajectory at the specific time, the position deviation data, the speed deviation data, the safety time parameter, and the time period parameter.

6. The method according to claim 1, wherein:
the training travel trajectory is determined using the assumed speed of the vehicle at a specific time, and
the assumed speed of the vehicle is determined using the assumed position of the vehicle on the travel trajectory at the specific time, a current assumed speed of the vehicle on the travel trajectory at the specific time, the position deviation data, the speed deviation data, the safety time parameter, and the time period parameter.

7. The method according to claim 1, wherein the individual assumed positions and/or assumed speeds of the vehicle in the training travel trajectory is determined by a determination of the positions and/or velocities for different times on the training travel trajectory.

8. The method according to claim 1, wherein the training travel trajectory is determined such that the assumed speed of the vehicle is non-negative at all positions and/or times in the training travel trajectory.

9. The method according to claim 1, wherein the training travel trajectory is determined such that a lateral acceleration, which does not exceed a lateral acceleration threshold value, acts on the vehicle moving according to the training travel trajectory.

10. The method according to claim 1, wherein at least one step of the method is iteratively repeated when the training travel trajectory represents a driving behavior of the vehicle over a greater time interval than the safety time parameter.

11. The method according to claim 1, wherein an apparatus is configured to perform the method and/or to control steps of the method.

12. A method for training an autonomously driving vehicle, comprising:
adapting a driving algorithm using a training travel trajectory generated according to the method of claim 1.

13. The method according to claim 1, wherein a computer program is configured to perform the method and/or to control steps of the method.

14. A machine-readable storage medium on which a computer program is stored, the computer program configured to perform and/or to control steps of the method of claim 1.
